(19) United States
(12) Patent Application Publication
(10) Pub. No.: US 2010/0255783 A1
(43) Pub. Date: Oct. 7, 2010

(54) APPARATUS AND METHOD FOR RECEIVING AUDIO SIGNALS USING BLUETOOTH

(75) Inventor: IL-Hwan KIM, Gunpo-si (KR)

Correspondence Address: CANTOR COLBURN, LLP, 20 Church Street, 22nd Floor, Hartford, CT, 06103, US

(73) Assignee: M DESIGNS INC., Gunpo-si (KR)

(21) Appl. No.: 12/751,344

(22) Filed: Mar. 31, 2010

(30) Foreign Application Priority Data
Apr. 2, 2009 (KR) 10-2009-0028622

(51) Int. Cl. H04B 7/00

(52) U.S. Cl. 455/41.2

(57) ABSTRACT

Disclosed is an apparatus for receiving audio signals using a Bluetooth, which is connected to an amplifier through a microphone line, searches and connects a connectable Bluetooth device when power is supplied, receives audio signals from the connected Bluetooth device, converts the received and processed digital audio signals into analogue audio signals and outputs the converted analogue audio signals to the amplifier through a microphone line connected to a connector unit, and it is possible to widen the user's range of activities, free the user's action and remove the fatigue due to the weight of the wire microphone since it can conduct the function of the wire microphone by connecting a Bluetooth audio receiver having the same connector type as the wire microphone with a connector for connecting the wire microphone.

### BACKGROUND OF THE INVENTION

1. Field of the Invention

The present invention relates to an apparatus for receiving audio signals, and more particularly, to apparatus and method for receiving audio signals using a Bluetooth, which receive the audio signals using the Bluetooth, convert the digital audio signals into analogue audio signals and transmit the analogue audio signals to an output device to output the analogue audio signals through the output device.

2. Description of Related Art

In churches, classrooms of universities and private educational institutes, wire microphones are now widely used by priests, professors and lecturers to transfer their voices.

Wireless microphones are usually used in broadcasting stations, and the wireless microphone is used together with a separate receiver using frequencies and has a structure different from the wire microphone.

As such, the structure in which a wire microphone is connected to an amplifier and lecturer's voice is outputted through a speaker provided in a lecture room is generally used in various places, particularly in places where lectures are made.

Since the wire microphone should be used with being held by the lecturer's hands, the lecturer's hands cannot be used in other uses during the lecture and this restricts the lecturer's action.

Also, the lecturer may feel fatigue due to the weight of the wire microphone when the lecture lasts for a long time.

### SUMMARY OF THE INVENTION

An object of the present invention is to provide apparatus and method for receiving audio signals using a Bluetooth which allow receiving and output of the audio signals through the Bluetooth.

Another object of the present invention is to provide apparatus and method for receiving audio signals using a Bluetooth which are provided with a connector that corresponds to a connector of a wire microphone to allow the output with a conventional structure of an amplifier.

Further another object of the present invention is to provide apparatus and method for receiving audio signals using a Bluetooth which receive digital signals, transform the digital signals into analogue signals and output the analogue signals through the amplifier.

To achieve the above and other objects, an apparatus for receiving audio signals, which is interconnected with a Bluetooth terminal to receive the audio signals using a Bluetooth, in accordance with the present invention includes a wireless connection key for turning the device into a Bluetooth standby status; a Bluetooth signal processing unit for converting the digital audio signals received from the Bluetooth terminal into analogue signals and outputting the converted analogue signals; a connector unit for outputting the analogue audio signal outputted from the Bluetooth signal processing unit to the outside; a control unit for conducting overall control so as to receive the audio signals from the Bluetooth terminal and convert the digital audio signals into the analogue audio signals and output the converted analogue audio signals to the outside output device through the connector unit; and a power supply unit for supplying power.

Preferably, the apparatus for receiving audio signals using a Bluetooth further includes a host/slave converting key for selecting a host and a slave according to a Bluetooth terminal to be connected.

Preferably, the apparatus for receiving audio signals using a Bluetooth further includes a display unit for displaying the list of the searched connectable Bluetooth terminals and displaying host/slave status.

Preferably, the Bluetooth signal processing unit includes a signal receiving unit for receiving carrier wave signals modulated into Bluetooth signals, a data processing unit for demodulating the carrier wave signals to the Bluetooth signals, a digital/analogue (D/A) converting unit for converting the demodulated Bluetooth signals into the analogue audio signals, and an analogue signal outputting unit for converting the decoded analogue audio signals into balance output.

Preferably, the connector unit has shapes of male and female parts of a balanced cable.

Preferably, the power supply unit is provided with a lithium polymer battery, which enables charge through an exclusive charger or a universal 24-pin charger for cellular phones.

Also, a method for receiving audio signals using a Bluetooth in accordance with the present invention includes: connecting to an amplifier through a microphone line; searching and connecting a connectable Bluetooth device when power is supplied; receiving audio signals from the connected Bluetooth device; converting the received and processed digital audio signals into analogue audio signals; and outputting the converted analogue audio signals to the amplifier through a microphone line connected to a connector unit.

Preferably, the connection with the amplifier is conducted such that the connector unit having a shape of a female part of a balanced cable is coupled with a male-shaped jack of the microphone line.

Preferably, it is possible to select a mode using a host/slave converting key when connecting the searched Bluetooth device.

Preferably, the receiving the audio signals from the Bluetooth device and outputting the received audio signals as analogue signals includes: receiving carrier wave signals modulated to Bluetooth signals; demodulating the carrier wave signals to the Bluetooth signals; converting the demodulated Bluetooth signals into analogue audio signals; and converting the decoded analogue audio signals into balance output.

As described above, since the present invention can conduct the function of the wire microphone as it converts the audio signals received from the Bluetooth device into analogue audio signals and output the converted analogue audio signals through a connect which is connectable with a microphone line, it is possible to widen the user's range of activities, free the user's action and remove the fatigue due to the weight of the wire microphone.

Also, since the connector which is the same as the output terminal of the wire microphone and thus is able to be connected through the line of a conventionally used wire microphone, it is possible to output the audio signals with the same amplifier structure.

### BRIEF DESCRIPTION OF THE DRAWINGS

FIG. 1 is a block diagram illustrating a structure which receives audio signals through a Bluetooth and outputs the audio signals to an amplifier in accordance with a preferred embodiment of the present invention.

FIG. 2 is a block diagram illustrating a structure of the audio receiver in accordance with a preferred embodiment of the present invention.

FIG. 3 is a view illustrating the connector unit in accordance with a preferred embodiment of the present invention.

FIG. 4 is a flowchart illustrating a procedure of receiving the audio signals through a Bluetooth and outputting the audio signals to the amplifier in accordance with a preferred embodiment of the present invention.

### DESCRIPTION OF SPECIFIC EMBODIMENTS

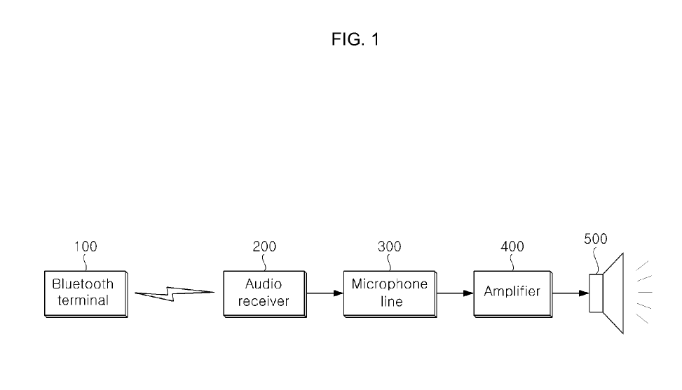

Hereinafter, preferred embodiments of the present invention will be described in detail with reference to FIGS. 1 through 4.

FIG. 1 is a block diagram illustrating a structure which receives audio signals through a Bluetooth and outputs the audio signals to an amplifier in accordance with a preferred embodiment of the present invention.

Referring to FIG. 1, the structure which receives audio signals through a Bluetooth and outputs the audio signals to an amplifier includes a Bluetooth terminal 100 which is able to output audio signals through a Bluetooth, an audio receiver 200 which is able to receive the audio signals from the Bluetooth terminal through a Bluetooth module, a microphone line 300 for transmitting the audio signals from the Bluetooth receiver 200 to an amplifier, the amplifier 400 for amplifying the transmitted audio signals, and a speaker 500 for outputting the audio signals to the outside.

The Bluetooth terminal 100 is a terminal with a built-in Bluetooth sending/receiving module, and includes a Bluetooth ear/head set which is interconnected with a cellular phone, a head set with a microphone function which is interconnected with a dongle of a PC or is able to receive voice signals, or audio signals from a terminal equipped with a Bluetooth function, or a cellular phone.

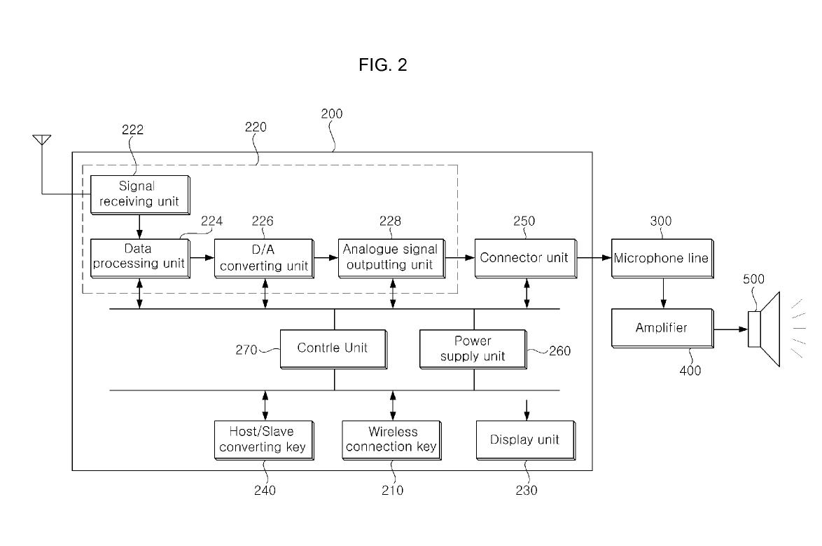

The audio receiver 200 is the subject matter of the present invention and will be described in detail with reference to FIG. 2.

The microphone line 300 is provided with a female part of a balanced cable at one end and a canon jack at the other end and is connected to an input terminal of the amplifier.

The amplifier 400 is a device for conducting an amplifying operation and is a device which amplifies amplitudes of electromagnetic waves to increase intensities thereof in wireless communications, radios and so on.

In the present invention, the amplifier receives and amplifies the audio signals and outputs the amplified audio signals through the speaker 500.

The speaker 500 may be included in the amplifier 400 or otherwise may be placed in a different place by connection through a separately provided output line.

FIG. 2 is a block diagram illustrating a structure of the audio receiver in accordance with a preferred embodiment of the present invention.

The device which is interconnected with the Bluetooth terminal to receive the audio signals includes a wireless connection key 210 for turning the device into a Bluetooth standby status, a Bluetooth signal processing unit 220 for converting the digital audio signals received from the Bluetooth terminal 100 into analogue signals and outputting the converted analogue signals, a connector unit 250 for outputting the analogue audio signal outputted from the Bluetooth signal processing unit 220 to the outside, a control unit 270 for conducting overall control so as to receive the audio signals from the Bluetooth terminal 100 and convert the digital audio signals into the analogue audio signals and output the converted analogue audio signals to the outside output device through the connector unit 250, and a power supply unit 260 for supplying power.

Also, a host/slave converting key 240 for selecting a host and a slave according to a Bluetooth terminal 100 to be connected, and a display unit 230 for displaying the list of the searched connectable Bluetooth terminals 100 and displaying host/slave status are further provided.

The Bluetooth signal processing unit 220 is provided with a signal receiving unit 222 for receiving carrier wave signals modulated into Bluetooth signals, a data processing unit 224 for demodulating the carrier wave signals to the Bluetooth signals, a digital/analogue converting unit 226 for converting the demodulated Bluetooth signals into the analogue audio signals, and an analogue signal outputting unit 228 for converting the decoded analogue audio signals into balance output.

The display unit 230 may consist of LCD so as to display entire information about the status of the device, or otherwise may consist of 2 LEDs for displaying connection status and standby status.

The power supply unit 260 is provided with a lithium polymer battery, which enables charge through a separately provided charger to thereby ensure long operation time.

Also, the structure in which the power is also supplied from a volatile battery such as AA and AAA can be employed for the case when the charge is not possible.

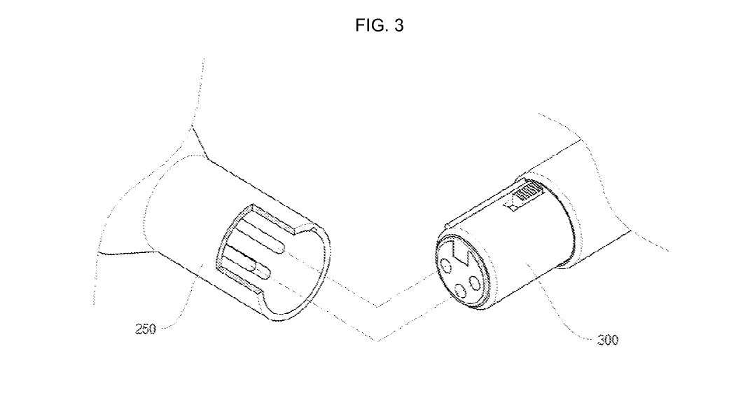

FIG. 3 is a view illustrating the connector unit in accordance with a preferred embodiment of the present invention.

Referring to FIG. 3, the connector unit 250 has the same structure as the output terminal of a wire microphone which is of a shape of a female part of a balanced cable and is coupled with a male-shaped jack of the microphone line 300.

Therefore, it is possible to easily connect the audio receiver 200 to any conventional structure that employs a wire microphone.

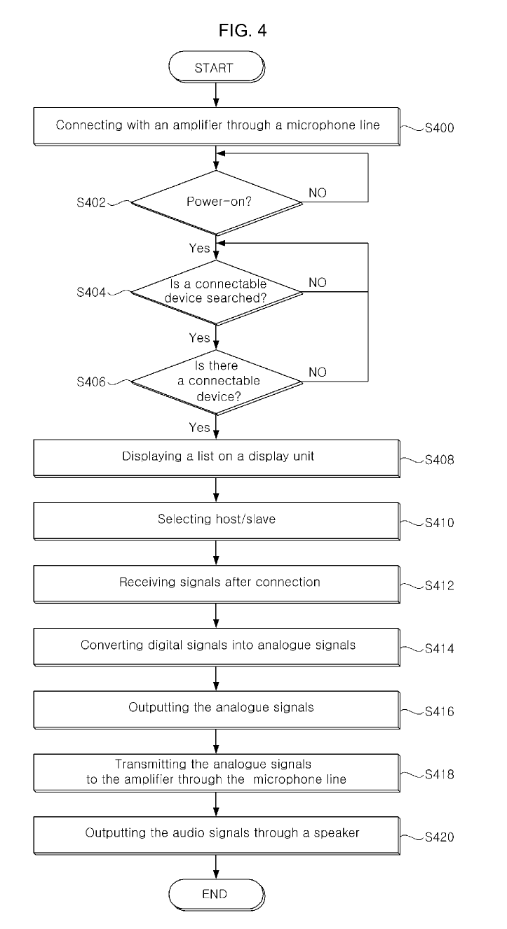

FIG. 4 is a flowchart illustrating a procedure of receiving the audio signals through a Bluetooth and outputting the audio signals to the amplifier in accordance with a preferred embodiment of the present invention.

In one embodiment, following is a process in which the lecturer's voice inputted through an ear/head set, or the Bluetooth terminal 100, is received by the audio receiver 200 using the Bluetooth and inputted into the amplifier 400 through the above described structure.

The lecturer removes the wire microphone which has been used so far and connects the audio receiver 200 to the microphone line 300 (S400).

When the connector unit 250 provided in the audio receiver 200 is connected to the microphone line 300, power supply is started (S402).

Then, the lecturer pushes the wireless connection key 210 provided in the audio receiver 200 to try the connection with the ear/head set (S404, S406).

The lecturer confirms that the list of connectable ear/head set is displayed on the display unit 230 (S408).

A slave mode should be selected in order to use an ear/head set that is provided with a module capable of searching and selecting Bluetooth devices and a host mode should be selected so as to use the ear/head set as a slave when the head set has no separate searching module (S410).

When the connection is completed, the lecturer's voice is inputted to the ear/head set and the inputted audio signals are transmitted to the audio receiver 200 through the Bluetooth (S412).

The carrier wave signals transmitted to the audio receiver 200 and modulated into Bluetooth signals are received in the signal processing unit 220; the data processing unit 224 demodulates the carrier wave signals to the Bluetooth signals; the D/A converting unit 226 converts the demodulated Bluetooth signals into the analogue audio signals; and the analogue signal output unit 228 converts the decoded analogue audio signals into the balance output to output balance output to the connector unit 250.

The outputted analogue audio signals is transmitted to the amplifier 400 through the microphone line 300 and outputted to the outside through the speaker 500.

Consequently, it conducts the function of the wire microphone through the output procedure from the connector unit 226 of the audio receiver 200.

As described above, by receiving the audio signals from a device which is provided with a Bluetooth module and is able to input/output the audio signals, converting the received audio signals into the analogue signals to output the converted analogue signals through the connector which is the same as the output terminal of a wire microphone, and inputting the analogue signals into the amplifier through the microphone line to output the analogue signals to the outside, it is possible to widen the user's range of activities, free the user's action and remove the fatigue due to the weight of the wire microphone, and it is also possible to prevent generation of noise due to howling since the digital audio signals are outputted.

Also, since the connector which is the same as the output terminal of the wire microphone and thus is able to be connected through the line of a conventionally used wire microphone, it is possible to output the audio signals with the same amplifier structure.

While the present invention has been described with respect to the specific embodiments, it will be apparent to those skilled in the art that various changes and modifications may be made without departing from the spirit and scope of the invention as defined in the following claims.

While the present invention has been described with respect to the specific embodiments, it will be apparent to those skilled in the art that various changes and modifications may be made without departing from the spirit and scope of the invention as defined in the following claims.

What is claimed is:

1. An apparatus for receiving audio signals, which is interconnected with a Bluetooth terminal to receive the audio signals using a Bluetooth, comprising: a wireless connection key for turning the device into a Bluetooth standby status, a Bluetooth signal processing unit for converting the digital audio signals received from the Bluetooth terminal into analogue signals and outputting the converted analogue signals, a connector unit for outputting the analogue audio signal outputted from the Bluetooth signal processing unit to the outside, a control unit for conducting overall control so as to receive the audio signals from the Bluetooth terminal and convert the digital audio signals into the analogue audio signals and output the converted analogue audio signals to the outside output device through the connector unit, and a power supply unit for supplying power.

2. The apparatus of claim 1, further comprising: a host/slave converting key for selecting a host and a slave according to a Bluetooth terminal to be connected.

3. The apparatus of claim 1, further comprising: a display unit for displaying the list of the searched connectable Bluetooth terminals and displaying host/slave status.

4. The apparatus of claim 1, wherein the Bluetooth signal processing unit includes a signal receiving unit for receiving carrier wave signals modulated into Bluetooth signals, a data processing unit for demodulating the carrier wave signals to the Bluetooth signals, a digital/analogue (D/A) converting unit for converting the demodulated Bluetooth signals into the analogue audio signals, and an analogue signal outputting unit for converting the decoded analogue audio signals into balance output.

5. The apparatus of claim 1, wherein the connector unit has shapes of male and female parts of a balanced cable.

6. The apparatus of claim 1, wherein the power supply unit is provided with a lithium polymer battery, which enables charge through an exclusive charger or a universal 24-pin charger for cellular phones.

7. A method for receiving audio signals using a Bluetooth, comprising: connecting to an amplifier through a microphone line; searching and connecting a connectable Bluetooth device when power is supplied; receiving audio signals from the connected Bluetooth device; converting the received and processed digital audio signals into analogue audio signals; and outputting the converted analogue audio signals to the amplifier through a microphone line connected to a connector unit.

8. The method of claim 7, wherein the connection with the amplifier is conducted such that the connector unit having a shape of a female part of a balanced cable is coupled with a male-shaped jack of the microphone line.

9. The method of claim 7, wherein it is possible to select a mode using a host/slave converting key when connecting the searched Bluetooth device.

10. The method of claim 7, wherein the receiving the audio signals from the Bluetooth device and outputting the received audio signals as analogue signals includes: receiving carrier wave signals modulated to Bluetooth signals; demodulating the carrier wave signals to the Bluetooth signals; converting the demodulated Bluetooth signals into analogue audio signals; and converting the decoded analogue audio signals into balance output.
